(19) United States
(12) Patent Application Publication
(10) Pub. No.: US 2011/0231897 A1
(43) Pub. Date: Sep. 22, 2011

(54) Systems and Methods for Mediating the Delivery of Internet Service

(76) Inventor: Tom C. Tovar, San Francisco, CA (US)

(21) Appl. No.: 12/897,732

(22) Filed: Oct. 4, 2010

Related U.S. Application Data
(63) Continuation-in-part of application No. 12/727,001, filed on Mar. 18, 2010.
(60) Provisional application No. 61/370,556, filed on Aug. 4, 2010.

(51) Int. Cl. G06F 21/00; G06F 15/16

(52) U.S. Cl. 726/1

(57) ABSTRACT

Systems and methods for mediating the delivery of Internet service are provided herein. According to some exemplary embodiments a method for mediating the delivery of Internet service includes a processor executing instructions stored in a memory to selectively apply a mediation policy to the Internet service according to an administrator-defined schedule, wherein only Internet content included in the mediation policy is accessible when the mediation policy is applied to the Internet service, wherein the Internet content comprises educationally appropriate Internet content for at least one end user.

### CROSS-REFERENCE TO RELATED APPLICATIONS

This nonprovisional patent application is a continuation-in-part application that claims the priority benefit of U.S. patent application Ser. No. 12/727,001 filed on Mar. 18, 2010, titled “Internet Mediation,” and provisional U.S. Patent Application Ser. No. 61/370,556, filed on Aug. 4, 2010, titled “Internet Mediation Applications,” which are hereby incorporated by reference in their entirety.

### FIELD OF THE INVENTION

The present invention relates generally to mediating the delivery of Internet content, and more specifically, but not by way of limitation, to systems and methods that are capable of selectively applying a mediation policy to Internet content according to an administrator-defined schedule, wherein only Internet content included in the mediation policy is accessible when the mediation policy is applied to the Internet service.

### SUMMARY OF THE INVENTION

According to exemplary embodiments, the present invention provides a method for mediating the delivery of Internet service, the method including executing instructions stored in a memory by a processor to selectively apply a mediation policy to the Internet service according to an administrator-defined schedule, wherein only Internet content included in the mediation policy is accessible when the mediation policy is applied to the Internet service, wherein the Internet content comprises educationally appropriate Internet content for at least one end user.

According to other exemplary embodiments, the present invention is directed to a system for mediating the delivery of Internet service, the system having a memory for storing a program and a processor for executing the program that includes a mediation policy module that selectively applies a mediation policy to the Internet service according to an administrator-defined schedule, wherein only Internet content included in the mediation policy is accessible when the mediation policy is applied to the Internet service, wherein the Internet content comprises educationally appropriate Internet content for at least one end user.

According to additional exemplary embodiments, the present invention is directed to a computer readable storage medium having a program embodied thereon, the program executable by a processor in a computing system to perform a method of mediating the delivery of Internet service, the method including executing instructions stored in a memory by a processor to selectively apply a mediation policy to the Internet service according to an administrator-defined schedule, wherein only Internet content included in the mediation policy is accessible when the mediation policy is applied to the Internet service, wherein the Internet content comprises educationally appropriate Internet content for at least one end user.

### BRIEF DESCRIPTION OF THE DRAWINGS

FIG. 1 is an exemplary architecture of an education-based mediation policy application in accordance with various embodiments of the present invention.

FIG. 2 is a flow chart of an exemplary method for creating and selectively applying an education-based mediation policy to an Internet service.

FIG. 3 is an exemplary representation of a web page for subscribing to the mediation application.

FIG. 4A is an exemplary representation of a web page such as a configuration drawer for creating and/or editing an administrator-defined schedule for selectively applying a mediation policy.

FIG. 4B is an exemplary representation of a web page for creating and/or editing a list of educationally appropriate websites.

FIG. 4C is an exemplary representation of a blocking web page.

FIG. 5 is a block diagram of a DNS network arrangement in accordance with various embodiments of the present invention.

FIG. 6 is a block diagram of an exemplary system for providing variable content control for Internet user in accordance with various embodiments of the present invention.

FIG. 7 is a block diagram of an exemplary system for providing notifications regarding Internet access in accordance with various embodiments of the present invention.

### DETAILED DESCRIPTION OF EXEMPLARY EMBODIMENTS

While this invention is susceptible of embodiment in many different forms, there is shown in the drawings and will herein be described in detail several specific embodiments with the understanding that the present disclosure is to be considered as an exemplification of the principles of the invention and is not intended to limit the invention to the embodiments illustrated. According to exemplary embodiments, the present technology is directed to systems and methods for mediating the delivery of Internet service delivered to an end user on a network. More specifically, the systems and methods allow for the creation and enforcement of education-based mediation policies that promote study time for one or more end users by selectively applying an education-based mediation policy to the Internet service according to an administrator-defined schedule, wherein only Internet content included in the education-based mediation policy is accessible when the education-based mediation policy is applied to the Internet service.

Generally speaking, an administrator may selectively apply a mediation policy to the Internet service, the mediation policy affecting one or more end users that utilize computing systems coupled to the Internet service delivered to a location, such as a home, residence, place of business, campus, etc. The term “administrator” may include not only individuals, such as parents, but also any individual creating a mediation policy regarding the Internet service delivered to end users. It will be understood that an administrator may also be an end user, although end users who are not also administrators may not typically create or selectively apply mediation policies.

It will be further understood that because of the diversity of computing devices that may connect to the Internet service, the mediation policy may be applied to the Internet service rather than requiring the mediation policy to affect each computing device individually, such as a mediation application resident on each computing device. In various exemplary embodiments a value-based mediation policy (or at least a portion of the mediation policy application) may also reside as a stand alone application on one or more of the computing devices.

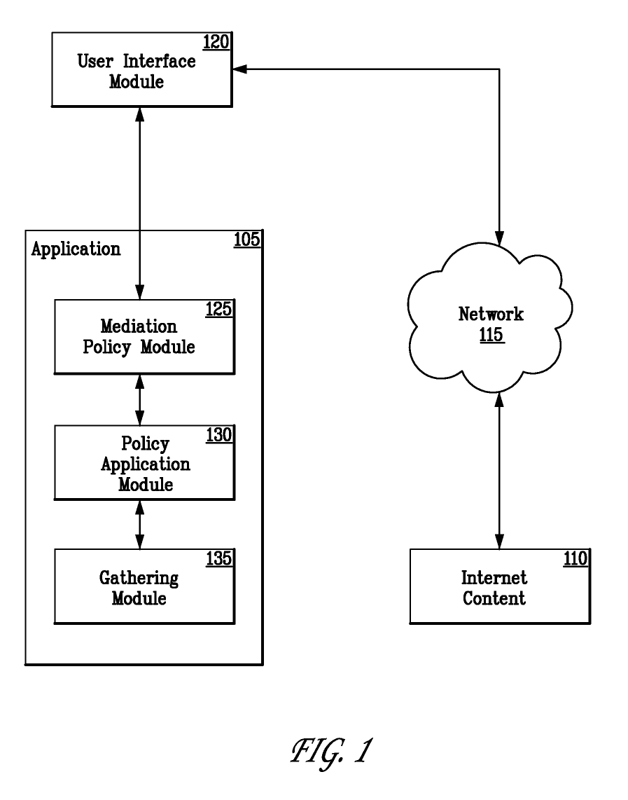

Referring now to FIG. 1, an exemplary architecture 100 of an exemplary mediation policy application 105 resident on the computing system (described in greater detail in FIG. 7 as computing system 700) is shown. The computing system 700 may access Internet content 110 via network 115 utilizing user interfaces generated by the user interface module 120. Generally speaking, the mediation policy application 105 allows an administrator to create and selectively apply a customized education-based mediation policy that includes a white list of content deemed to be educationally appropriate for one or more end users. The education-based mediation policy is selectively applied to the Internet service according to an administrator-defined schedule (e.g., any given period of time established by an administrator corresponding to a “study time” for the end users). Study time may include a particular period of time each day after school, every other day after school, or in an on-demand fashion according to the needs of the end user. The educational mediation policy, when applied to the Internet service provided to the end user, allows access only to a white list of educational Internet content.

Rather than blocking access to all Internet content during study time, administrators may leverage the educational power of Internet by providing access to only educationally appropriate Internet content during study time. Providing access to only educationally appropriate Internet content ensures that the end users use educational Internet content to complete assignments and projects efficiently and productively.

It is important to note that the mediation policy application does not simply provide blocking mechanisms by masking or enabling network controls, but rather mediates Internet service provided to one or more end users on a network. As used herein, mediating the Internet service may include any of blocking, constraining, enabling, redirecting, promoting, demoting, substituting, obscuring, limiting, interrupting, and restricting all or a portion of the Internet service during study time.

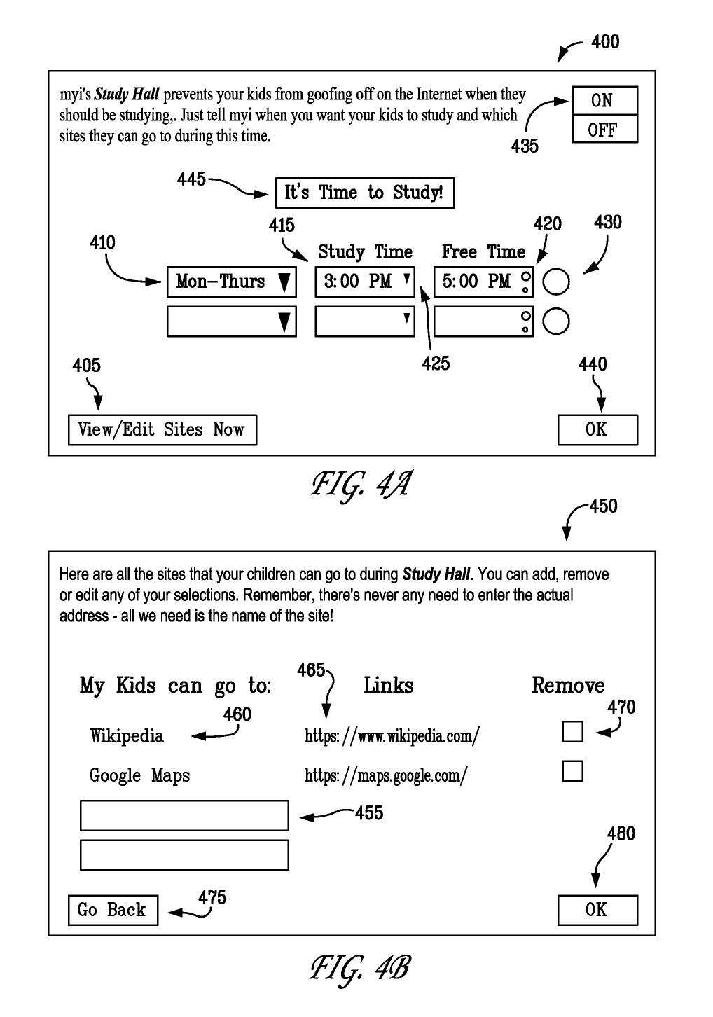

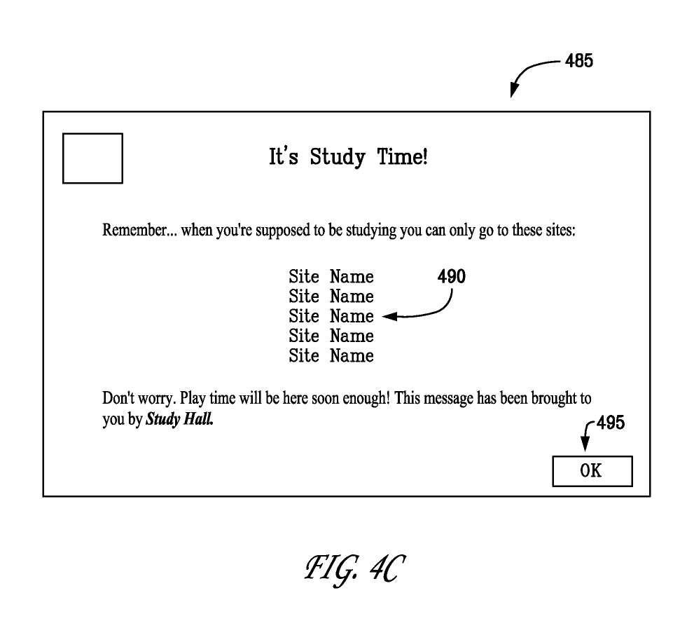

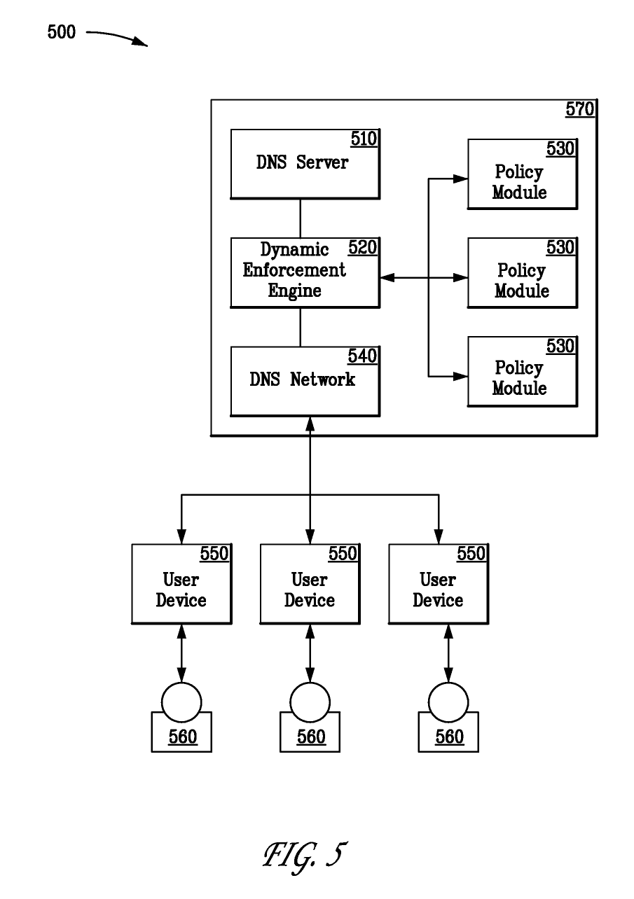

The mediation policy application 105 allows for the creation of educational mediation polices via a user interface such as a web page. A user interface module 120 may generate the user interface 610. The user interface 610 may be implemented in many embodiments, although in various exemplary implementations, the user interface 610 includes web pages 400 and 450 adapted to receive educational mediation information from an administrator, as illustrated in FIGS. 4A and 4B collectively.

According to exemplary embodiments, the mediation policy application 105 may include a mediation policy module 125, a policy application module 130, and an optional gathering module 135. It is noteworthy that the mediation policy application 105 may be composed of more or fewer modules and engines (or combinations of the same) and still fall within the scope of the present technology. After determining mediation policies the application 105 may communicate directly with the network 115.

In general, the mediation policy module 125 may create education-based mediation policies that are applied to the Internet service by the policy application module 130. More specifically, the mediation policy module 125 creates a mediation policy by receiving information indicative of administrator-defined Internet content that includes educationally appropriate Internet content 110.

It will be understood that the administrator-defined Internet content may also include Internet content determined to be educationally appropriate by an educational institution such as a school. The educational institution may promulgate and disseminate a list of educationally appropriate Internet content for each student or groups of students to the end user administrator. These lists may be imported into the mediation policy via the mediation policy module 125. For example, children in a particular grade (e.g., fifth, sixth, etc.) may receive a list of educationally appropriate Internet content based upon the monthly educational pursuits corresponding to their grade. In greater detail, children in the sixth grade may study American history. Therefore, an example of educationally appropriate Internet content established by the educational institution may include the domain name of the website corresponding to the Library of Congress.

Administrator-defined Internet content may also include Internet content collaboratively determined to be educationally appropriate by a group of end users invited by the administrator to collaborate on the educational relevance of Internet content used in the mediation policy. The administrator may, before or after the administrator creates the administrator's own mediation policy, invite the administrator's family members, friends, colleagues or any group of combination of groups and individuals to identify educationally appropriate Internet content to be used by the administrator in creating the administrator's own mediation policy. These invitees may or may not be users of the Internet service but will be allowed to contribute to the administrator's mediation policy via the user interface of the Internet service. The administrator may choose to moderate the contributions of individuals or groups invited by the administrator to contribute to the administrator's mediation policy. The administrator may also, before or after the administrator creates the administrator's own mediation policy, join an existing group of users of the Internet service and apply the determinations of educational relevance of Internet content by a group to the administrator's own mediation policy. Where there is an existing group that the administrator joins for purposes of creating a mediation policy, the administrator may choose to import the contributions of other groups once or subscribe to these groups to reduce the configuration burden of creating a mediation policy. After the administrator creates the administrator's own mediation policy, the administrator may publish the administrator's mediation policy to be used and/or subscribed to by other users of the Internet service. In such case, other users of the Internet service may import the contributions of administrator once or subscribe to the administrator's mediation policy for use in their own mediation policies. It is understood that via this collaboration two or more user-administrators may combine their mediation policies to create one mediation policy that may be used by these and other administrators of the Internet service.

Additionally, the mediation policy module 125 may also utilize the age of the end user to locate Internet content determined to be educationally appropriate for end users equal to the age of the end user. In various embodiments of the present technology, the mediation policy module 125 locates educationally appropriate Internet content 110 from Internet content records residing in the database. Each Internet content record corresponds to a particular age (e.g., 5, 6, 7, etc.) and includes Internet content determined to be educationally appropriate for that particular age or age group. It will be understood that Internet content records may be cumulative. For example, a Internet content record for end users six years of age includes Internet content 110 determined to be educationally appropriate for end users six years of age, but may also include all Internet content 110 determined to be educationally appropriate for end users less than six years of age. Mediation policies may also be socially produced, i.e. produced by a group of otherwise unrelated people, and shared by unrelated groups of administrators.

Internet content records may be populated by executing the optional gathering module 135 to gather Internet content 110 by way of web crawling or spidering the Internet. It will be understood that systems and methods for gathering or locating Internet content 110 (such as web crawling or spidering) are beyond the scope of this application, but would be readily understood and applied to the present disclosure by one of ordinary skill in the art.

The mediation policy module 125 is then executed to evaluate Internet content 110 located by the gathering module 135 for educational appropriateness relative to the age of the end user. Next, the mediation policy module 125 arranges the evaluated Internet content 110 into a Internet content record corresponding to a particular age.

It will be understood that the gathering module 135 may automatically and continuously, or periodically, locate additional Internet content 110 so that the Internet content records may continually evolve/grow over time.

Utilizing the received information, the mediation policy module 125 locates educationally appropriate Internet content 110 corresponding to the received administrator-defined Internet content along with educationally appropriate Internet content 110 corresponding to the age of the at least one end user. It will be understood that the mediation policy may only include information indicative of administrator-defined Internet content.

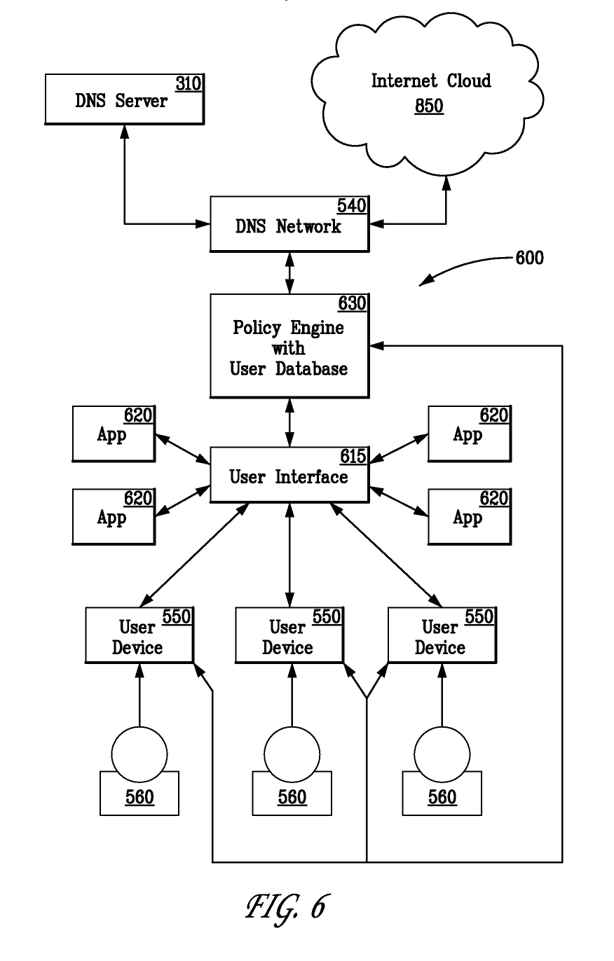

In some instances, the Internet service may be shared by a plurality of end users who may utilize one or more user devices 550 (see FIG. 5) at a particular location, such as a residence. As such, the mediation policy module 125 may be executed to create an educational zone by utilizing a white list of Internet content 110 that may be selected for all end users or each end user individually.

According to some embodiment, the mediation policy module 125 may receive information indicative of the age of the youngest end user. The mediation policy module 125 then compares the information indicative of the age of the youngest end user to Internet content records residing in the database to locate educationally appropriate Internet content 110 for the plurality of end users.

Alternatively, it will be understood that the mediation policy module 125 may be executed to create and apply a mediation policy for each end user in a more granular or user-specific manner, rather than applying a universal mediation policy to all end users based upon the age of the youngest end user.

With regard to creating mediation policies that are administrator defined, it will be understood that value systems can vary widely between groups of end users and administrators. For example, a parent (e.g., an administrator) may determine that their seven-year-old child should have access to additional educational Internet content 110 not included in a Internet content record corresponding to the age of the end user. As such, the parent may wish to include this additional educational Internet content 110. Allowing parents to include administrator-approved educational Internet content 110 permits the mediation policy application 105 to be flexible and adaptable.

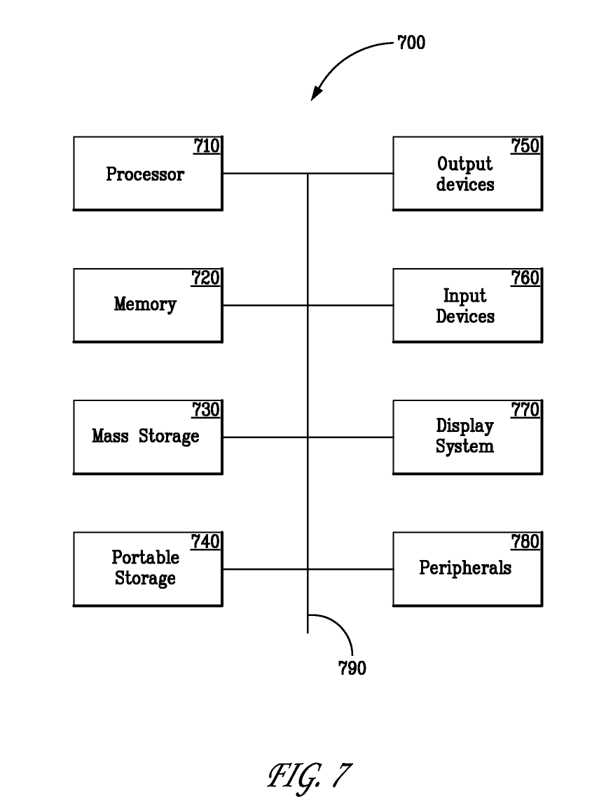

According to exemplary embodiments, a mediation policy may be created to selectively control access to particular websites. An administrator creates the education-based mediation policy for a group of users by inputting information indicative of one or more educationally appropriate domains. For example, an administrator may enter a domain name (e.g., “www.educationalsite.com”) of a domain, if known. Additionally, the administrator may enter only the name of the domain (e.g., “Educational Site” or “The Educational Site”). If the administrator enters a name of a domain, the mediation policy module 125 may evaluate the name to determine if there are one or more domains that correspond to the name. If there is only one domain that corresponds to the name, the mediation policy module 125 may automatically include the evaluated domain in the educational mediation policy. In contrast, if the mediation policy module 125 locates two or more domains corresponding to the name, the mediation policy module 125 may cause the user interface module 120 to display the located domain names. The administrator may then choose one or more of the located domains displayed by the user interface module 120. The chosen domains are then included in the mediation policy. These education-based mediation policies may be stored as user records that reside in the database. It will be understood that the database may include one or more databases, which can reside on at least one of the computing system 700 (see FIG. 7), the DNS server 510 (see FIG. 5), and the Internet cloud 650 based installation (see FIG. 6).

The education-based mediation policy may then be applied to the Internet service, to mediate the delivery of Internet service by execution of the policy application module 130. The policy application module 130 selectively applies the education-based mediation policy to the Internet service according to an administrator-defined schedule, wherein only Internet content included in the mediation policy is accessible when the mediation policy is applied to the Internet service.

More specifically, if the requested Internet content 110 is not included in the mediation policy, the policy application module 130 causes the dynamic enforcement engine 520 to perform at least one of the following actions: (1) prevent the DNS server 510 (FIG. 5) from resolving the Internet content 110 before the Internet service reaches the displays of the user devices 550; or (2) prevent the Internet service provider from resolving the Internet content 110 before the Internet service reaches the displays of the user devices 550. In the first case, the dynamic enforcement engine 520 may prevent the DNS server 510 from resolving the Internet content 110 by affecting commands and actions occurring on the DNS server 510. It will be understood that the policy application module 130 may reside on the DNS server 510.

The administrator, via utilization of the user interface 610, may terminate application of the mediation policy to the Internet service at any time. The user interface 610 may include a button (such as an enable/disable button 435 of exemplary FIG. 4A) or a check box that can be toggled by the administrator to enable/disable the application of the education-based mediation policy to the Internet service.

Additionally, if the policy application module 130 has denied access to Internet content 110, the policy application module 130 may cause the user interface module 120 to generate a user interface 610 in the form of a web page (not shown) that includes a blocking message. According to various embodiments, the user interface 610 includes a web page notifying the end user that access to the requested Internet content 110 has been denied by the mediation policy application 105.

According to other embodiments, the database may be used by the mediation policy module 125 to record and to notify administrators of various data relative to Internet access. The data collected from and provided to the administrators may include records of specific instances when access to Internet content 110 was blocked, such as when the dynamic enforcement engine 520 prevents resolution of the Internet content 110. Additionally, the mediation policy module 125 may record an aggregate number of times Internet content 110 was blocked in a predetermined amount of time. The data collected may be organized into logs that can be stored in a user record and accessed by the user interface module 120. More specifically, the user interface module 120 may generate a web page (not shown), including log data indicative of the date and time resolutions of Internet content 110 were denied along with information indicative of the Internet content 110.

According to the present disclosure, in some exemplary embodiments, the mediation policy may be applied to the Internet service, such that only Internet content 110 included in the mediation policy is accessible to end users utilizing a plurality of user devices 550. For example, the mediation policy may be created utilizing a first user device (not shown), such as a desktop computer operated by an administrator. A second user device (also not shown) or additional user devices coupled to the Internet service may only access Internet content 110 included within the mediation policy. It will be understood that the first user device and the second user device may be the same.

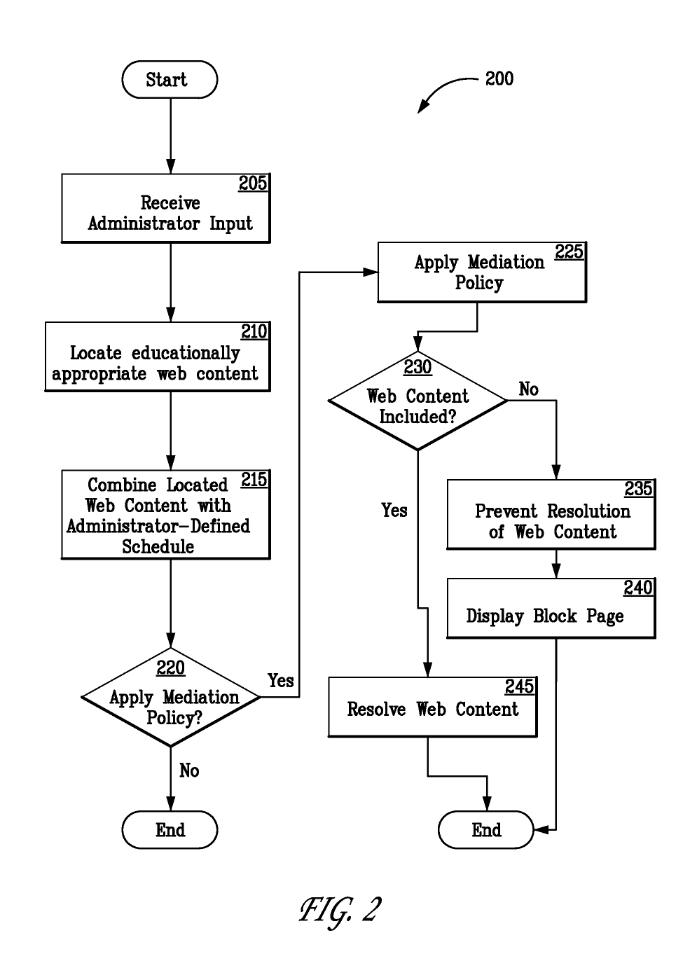

Referring now to FIG. 2, a method 200 for selectively applying a mediation policy to the Internet service according to an administrator-defined schedule is shown, wherein only Internet content included in the mediation policy is accessible when the mediation policy is applied to the Internet service. The method 200 begins with a step 205 of an administrator creating an education-based mediation policy for one or more end users by supplying input via a user interface displayed on the user device. For example, the user interface may display a variety of input fields to the administrator. One or more messages may be displayed on the user interface to elicit input from the administrator. The user interface may then receive input indicative of (i) information indicative of administrator-defined Internet content corresponding to educationally appropriate Internet content, and/or (ii) the age of at least one end user. It will be understood that administrator-defined Internet content may include educationally appropriate Internet content received from an educational institute. It will further be understood that the term “educational institute” may include a school, university, a tutor, a government entity, a non-governmental educational entity, and the like.

Input received by the user interface may be utilized by the education-based mediation policy module to create a mediation policy for one or more end users. For example, the administrator inputs information indicative of the age of an end user who is seven years of age. It will be understood that if a plurality of end users utilize a common Internet service, the administrator may input information indicative of the age of the youngest end user. It will further be understood that individual education-based mediation policies may be created for each end user.

A subsequent step 210 includes the mediation policy module locating educationally appropriate Internet content corresponding to the age of the end user, which in this case is seven years of age. The education-based mediation policy module locates Internet content educationally appropriate for a child who is seven years of age by searching databases associated with the mediation system that include Internet content records having information indicative of educationally appropriate Internet content. In this instance, the mediation policy module locates a Internet content record corresponding to an age of seven.

Next, in step 215, the administrator inputs information indicative of an administrator-defined schedule for applying the education-based mediation policy to the Internet service. In particular, the administrator-defined schedule may include a period of time, such as two hours for each day of the week corresponding to a study time for the end user. It will be understood that the period of time and day of the week are adjustable to suit the particular educational needs of the end user. For example, younger children may have shorter periods of time for study than older children, or may only have required study times two days per week, rather than four or five as is common with older children. After the administrator inputs an administrator-defined schedule, the mediation policy module combines the located educationally appropriate Internet content with information indicative of the administrator-approved Internet content to create an education-based mediation policy that may be selectively applied to the Internet service provided to the end user. The education-based mediation policy may then be stored in a database.

During study time, the end user is precluded from accessing Internet content that may distract the end user from their educational pursuits. Rather than blocking all Internet content, the administrator may enhance study time for the end user by allowing access to only a limited amount of educational Internet content such as the content included in the educational mediation policy.

Alternatively, rather than selecting a particular schedule, the administrator may apply the education-based mediation policy on-demand. If the administrator chooses to apply the education-based mediation policy in an on-demand manner, the mediation policy remains applied to the Internet service until the administrator chooses to terminate application of the mediation policy to the Internet service. It will be understood that in some embodiments, the on-demand application of the mediation policy may terminate after a predetermined period of time.

In an additional step 220, the administrator may enable/disable selective application of the education-based mediation policy to the Internet service. The administrator may enable/disable the selective application of the mediation policy via a button located on a user interface (such as the enable/disable button 435 of exemplary FIG. 4A). If the administrator does not enable the educational mediation policy, the method 200 terminates.

If the administrator enables application of the mediation policy, the method 200 further includes a step 225 of applying of the education-based mediation policy to the Internet service according to an administrator-defined schedule. More specifically, each application of the education-based mediation policy begins with an end user inputting a request to access Internet content. The end user may input this request via a browser operating on the user device. In various embodiments, a request includes clicking a hyperlink located on a web page.

In an additional step 230, the policy application module of the mediation application receives the request and compares the request against the mediation policy. If the policy application module determines that the Internet content is not included in the mediation policy, the policy application module causes the dynamic enforcement engine to prevent resolution of the Internet content in step 235.

In addition to preventing resolution of the requested Internet content, the policy application module may, in step 240, display a notification message to the end user in the form of a blocking web page. It will be understood that the user interface module may generate the blocking web page. The blocking web page may include the following content: a message that the attempt to access the requested Internet content has been denied; a message that the attempt was blocked by the educational mediation application (which may include the trade name of the application); a message that the administrator has established that the requested Internet content be blocked; and/or any combinations thereof. The method terminates after the dynamic enforcement engine prevents resolution of the Internet content and/or the user interface module generates and displays a notification message.

In contrast, if the policy application module determines that the Internet content is not included in the mediation policy, a step 245 allows the dynamic enforcement engine to permit resolution of the Internet content. The Internet content is then provided by the Internet service to the end user via the user device. It will be understood that the method terminates after resolution of the Internet content.

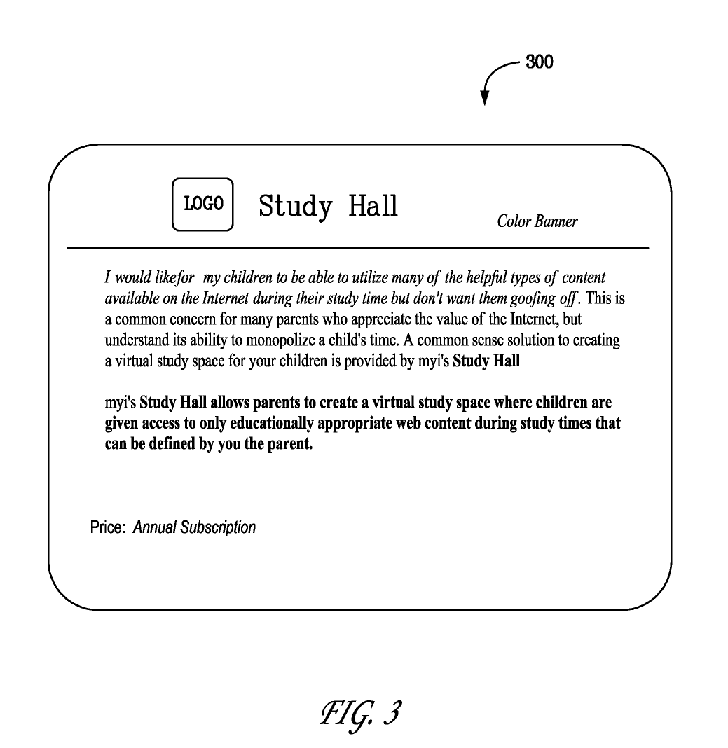

FIG. 3 illustrates an exemplary web page 300 for subscribing to the educational mediation application. The web page may include (i) content describing the functionality of the application; (ii) the name of the application (“Study Hall”); (iii) a link to more detailed information; and (iv) a price description.

FIG. 4A illustrates an exemplary user interface, which in this instance includes a web page 400 in the form of a configuration drawer by which a plurality of input devices may be configured to receive input from an administrator. The web page 400 includes view/edit button 405 that when clicked by the administrator displays additional input devices (see FIG. 4B) for receiving information indicative of one or more administrator-defined websites that are educationally appropriate for the end user. The web page 400 also includes input devices that allow the administrator to input an administrator-defined schedule for applying the mediation policy to the Internet service. Input devices may include dropdown menu 410 having selections corresponding to a particular day or group of days of the week to apply the mediation policy. The web page 400 may also include input devices that allow the administrator to choose an administrator-defined schedule for applying the mediation policy. Dropdown menu 415 may include selections corresponding a time to apply the mediation policy (e.g., study time) to the Internet service, for example 3:00 p.m. Additionally, dropdown menu 420 may include selections corresponding to a time when mediation application is not applied (e.g., free time) to the Internet service, for example 5:00 p.m. The input devices may also include adjustment buttons 425 that allow the administrator to increase or decrease the period of time by increments of, for example, fifteen minutes. Web page 400 may also include buttons 430 for choosing the administrator-defined schedule as selected and displayed in dropdown menus 410, 415, and 420, collectively.

An enable/disable button(s) 435 is included, allowing an administrator to selectively control application of the mediation policy by enabling/disabling the functionality of the mediation application. Once the administrator is finished inputting information of the mediation policy, the administrator may utilize button 440 to close the web page 400. It will be understood that rather than, or in addition to utilizing an administrator-defined schedule, an administrator may apply the mediation policy in an on-demand manner by utilizing button 445 that immediately applies the mediation policy to the Internet service. The administrator may also suspend application of the mediation policy by clicking button 445, or application may automatically terminate according to a predetermined period of time, such as the time defined by dropdown menu 420.

Upon utilization of view/edit button 405 web page 450 is displayed which may include text boxes 455 for receiving input indicative of one or more educationally appropriate websites from an administrator. The common name 460 of websites previously added to the white list may be displayed along with domain names 465 of corresponding to the common name. Web page 450 may also include check boxes 470 that when selected remove a previously added domain from the white list.

Web page 450 may also include back button 475, which closes web page 450 and displays web page 400. Once the administrator is finished editing the white list of educationally appropriate domains, button 480 may be selected to close web page 450.

FIG. 4C illustrates an exemplary user interface, which in this instance includes a blocking page 485. The blocking page 485 may include a message that their attempt to access a website has been denied, along with a list 490 of educationally appropriate websites included in the mediation policy. The blocking page 485 may also include a message that informs the end user that access to the requested website has been blocked by the mediation application, namely Study Hall. Lastly, the end user may close the blocking page 485 by utilizing button 495, which attempts to close the browser.

The systems and methods described above may typically be resident in an Internet service or a DNS network. The systems and methods described may also be implemented in plug-in utilities, gateway devices, cable modems, proxy servers, set top boxes, and network interface devices.

FIG. 5 illustrates an exemplary Internet service system 500, with a DNS server, that may be utilized to support the above described systems and methods. A DNS server 510 operates in conjunction with a dynamic enforcement engine 520. The dynamic enforcement engine 520 may operate in conjunction with one or more policy modules 530 to establish any applicable polices at the DNS 510 level. The content rules are applied to received user queries, and determine the content that is delivered by the DNS network 540 through various user devices 550 to the end users 560.

The dynamic enforcement engine 520 may generate its policy engine on instructions received from one or more policy modules 530. Each policy module 530 may be constructed to provide various types and levels of services to the DNS network 540. In various embodiments, a policy module 530 may be configured to handle queries directed to subjects including, but not limited to, malicious domain redirection, user access redirection, non-existent domain redirection, and data collection or analysis.

It will be recognized by those skilled in the art that the elements of DNS service 570 may be hosted either locally or remotely. In addition to residing in the DNS service 570, one or more of the DNS network 540, the dynamic enforcement engine 520, and the policy modules 530, and any combination thereof, may be resident on one or more user devices 550.

Exemplary user devices for use with the disclosed systems may include an app. As used herein, an app shall be defined as a module including a user interface to an Internet service. The app may further include one or more modules included in the Internet service. An app may be downloaded and installed on a user's computing device, including mobile devices. Users may define an access, mediation, or restriction policy via a user device, such as through the user interface. Some embodiments of the present invention do not require software to be downloaded or installed locally to the user device and, accordingly, do not require the user to execute a de-install application to cease use of the system.

FIG. 6 shows a schematic layout of an exemplary system 600 for implementing direct and variable end user control. FIG. 6 illustrates that the system 600 may operate installed on a DNS server 510, or with a cloud 650 based installation.

The system 600 utilizes a user interface 610. The user interface 610 may be implemented in many embodiments. One specific implementation of the user interface 610 is as a web page.

The user interface 610 may be accessed by one or more user devices 550 operated by the users 560. The user interface 610 may be accessed though a gateway user device 550 available to the users 560. Suitable user devices 550 include but are not limited to desktops, PCs, laptops, tablets, notebooks, gaming devices, IPods, IPhones, automobile computer systems, and Internet enabled TVs. The system 600 may also be accessed and controlled through other remote control user devices 550, such as a Smartphone. A Smartphone may be defined as a phone with computing capability. A Smartphone may provide the user 560 with Internet access.

The user interface 610 provides a mechanism for one or more authorized users 560 to establish content policy for the Internet service. The user interface 610 operates between the user devices 550 present in the system 600 and the DNS network 540. Instructions resident on the user interface 610 therefore operate on the Internet service, by controlling at least a portion of DNS resolutions via a dynamic policy engine 630, before the service reaches the displays of the user devices 550.

The user interface 610 provides the users 560 with access to one or more policy applications 620. The user interface 610 may provide access to a selection list to at least one authorized user 560. The authorized user 560 uses the selection list or some other menu mechanism to select those policy applications 620 that the user 560 chooses to apply to the system 600. The authorized user 560 may select any number of the available policy applications for use on the system 600 at any given time. In implementations utilizing Smartphones as the user device 550, the policy applications 620 are downloaded to the device 550. The device 550 then serves as the user interface 610 to communicate directly with the dynamic policy engine 630.

The policy applications 620 may prohibit access to specific Internet content. The policy applications 620 may also limit the time of day when users or selected users 560 may access certain Internet content. The policy applications 620 may also manage and analyze duration of access to various sites. It is important to note that the policy applications 620 do not simply provide blocking mechanisms by masking or enabling network controls, but rather mediate an Internet service received by the end user. As used herein, mediating the service may include any of blocking, constraining, enabling, redirecting, promoting, demoting, substituting, obscuring, limiting, interrupting, and restricting all or a portion of the Internet service. The policy applications 620 may provide notifications or alerts to one or more users 560 when sites are accessed. The policy applications 620 may also provide notification of frequency and duration of access of designated Internet content. The policy applications 620 may also be used to observe, substitute, enable, redirect users, to reward behavior desired from the users by a system administrator, etc. The policy applications 620 may redirect users from a non-favored Internet content to new content. The policy applications 620 may also collect and transmit data characteristic of Internet use.

Access policies supplied by the policy applications 620 may apply to all users 560 of the system 600, or the access policies may be specific to individual users or groups of users 560. The policy applications 620 may be discrete, single purpose applications.

The policy applications 620 provide the users 550 with a mechanism to take various actions relative to their Internet service feed. The policy applications 620 also allow the users 550 to establish a dynamic policy engine 630 that includes a user database. The policy engine 630 is used to enforce rules associated with each policy application associated with individual end users, not simply block various inappropriate sites from the Internet feed. Rather, the dynamic policy engine 630, controlled by the user interface 610 through user device(s) 550, is used to manage all aspects of the Internet experience for the users 560. In sum, the policy applications 620 may be used to configure the dynamic policy engine 630 to provide the users 560 with a mechanism to personalize the Internet experience. The policy applications 620 may be configured in combinations, and may each be separately configured.

The database in the policy engine 630 may be used to record and to notify users 560 of various data relative to Internet access. The data collected from and provided to the users 560 may include records of access of specific sites, time spent on specific sites, time of day of access, data specific to individual users, etc.

It should also be noted that following an initial setup through the user interface 610 of the policy engine 630, a direct access 640 enforcement loop may be established between the policy engine 630 and the user devices 550. Subsequent accessing of the DNS network 540 utilizing the direct access 640 decreases response time in the system 600, thereby further enhancing the Internet experience of the users 560. Configurations of policy applications 620 that are selected by one or more users 560 designated as system administrators may remain in the user database of the policy engine 630 until such time as it may be modified by the system administrators. The system administrators may define multiple policy configurations, with a combination of policy applications 620, applicable to one or more end users 560 of the system 600. Each policy application 620 may be separately configurable as well. Policy configurations may vary based upon designated times, conditional triggers, or specific requests from the users 560 with administrative authority.

As indicated above, two discrete data flow paths may be established for the system 600. A first data path establishes a set of enforcement policies for the system 600. The first data path flows from at least one user device 550 through the user interface 610, to the policy enforcement engine 630. A second data path 640 may be utilized following the establishment of a set of policies for the system 600. The second data path 640 flows directly between the user device(s) 550 and the policy engine 630. Multiple sets of enforcement policies may be established and saved within the system 600 and implemented selectively by the users 560.

FIG. 7 illustrates an exemplary computing system 700 that may be used to implement an embodiment of the present invention. System 700 of FIG. 7 may be implemented in the context of user devices 550, DNS server 510, Internet cloud 650 and the like. The computing system 700 of FIG. 7 includes one or more processors 710 and memory 720. Main memory 720 stores, in part, instructions and data for execution by processor 710. Main memory 720 can store the executable code when the system 700 is in operation. The system 700 of FIG. 7 may further include a mass storage device 730, portable storage medium drive(s) 740, output devices 750, user input devices 760, a graphics display 740, and other peripheral devices 780.

The components shown in FIG. 7 are depicted as being connected via a single bus 790. The components may be connected through one or more data transport means. Processor unit 710 and main memory 720 may be connected via a local microprocessor bus, and the mass storage device 730, peripheral device(s) 780, portable storage device 740, and display system 770 may be connected via one or more input/output (I/O) buses.

Mass storage device 730, which may be implemented with a magnetic disk drive or an optical disk drive, is a non-volatile storage device for storing data and instructions for use by processor unit 710. Mass storage device 730 can store the system software for implementing embodiments of the present invention for purposes of loading that software into main memory 710.

Portable storage device 740 operates in conjunction with a portable non-volatile storage medium, such as a floppy disk, compact disk or Digital video disc, to input and output data and code to and from the computer system 700 of FIG. 7. The system software for implementing embodiments of the present invention may be stored on such a portable medium and input to the computer system 700 via the portable storage device 740.

Input devices 760 provide a portion of a user interface. Input devices 760 may include an alphanumeric keypad, such as a keyboard, for inputting alphanumeric and other information, or a pointing device, such as a mouse, a trackball, stylus, or cursor direction keys. Additionally, the system 700 as shown in FIG. 7 includes output devices 750. Suitable output devices include speakers, printers, network interfaces, and monitors.

Display system 770 may include a liquid crystal display (LCD) or other suitable display device. Display system 770 receives textual and graphical information, and processes the information for output to the display device.

Peripherals 780 may include any type of computer support device to add additional functionality to the computer system. Peripheral device(s) 780 may include a modem or a router.

The components contained in the computer system 700 of FIG. 7 are those typically found in computer systems that may be suitable for use with embodiments of the present invention and are intended to represent a broad category of such computer components that are well known in the art. Thus, the computer system 700 of FIG. 7 can be a personal computer, hand held computing system, telephone, mobile computing system, workstation, server, minicomputer, mainframe computer, or any other computing system. The computer can also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the invention. Those skilled in the art are familiar with instructions, processor(s), and storage media.

It is noteworthy that any hardware platform suitable for performing the processing described herein is suitable for use with the invention. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. While the present invention has been described in connection with a series of embodiments, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art. For example, this description describes the technology in the context of an Internet service in conjunction with a DNS server. It will be appreciated by those skilled in the art that functionalities and method steps that are performed by a DNS server may be performed by an Internet service, and vice versa.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the invention as described herein.

One skilled in the art will further appreciate that the term “Internet content” comprises any content that may be accessed by an Internet access user device and may include web sites, domains, web pages, hyperlinks, URL's, any text, pictures, and/or media (such as video, audio, and any combination of audio and video) provide or displayed on a web page, and any combination thereof. Further a “mediation policy” may include any blocking, constraining, enabling, redirecting, promoting, demoting, substituting, obscuring, limiting and interrupting.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or subcombinations. Each of these processes or steps may be implemented in a variety of different ways. Also, while processes or steps are at times shown as being performed in series, these processes or steps may instead be performed in parallel, or may be performed at different times.

From the foregoing, it will be appreciated that specific embodiments of the system have been described herein for purposes of illustration, but that various modifications may be made without deviating from the spirit and scope of the system. Accordingly, the disclosure is not limited except as by the appended claims.

What is claimed is:

1. A method for mediating the delivery of Internet service at a specific location, the method comprising:
selectively applying a mediation policy to the Internet service according to an administrator-defined schedule, the mediation policy including only Internet content with educational value, the educational Internet content being accessible when the mediation policy is applied to the Internet service, the Internet content comprising educationally appropriate Internet content for at least one end user.

2. The method of claim 1, wherein educationally appropriate Internet content includes Internet content identified by an administrator.

3. The method of claim 1, wherein at least a portion of the educationally appropriate Internet content is defined by an educational institute.

4. The method of claim 1, wherein the mediation policy is created by the administrator or created by a group of users of the Internet service.

5. The method of claim 1, wherein the Internet service blocks delivery of Internet content to user devices according to the mediation policy in effect.

6. The method of claim 1, wherein the Internet service blocks delivery of Internet content to gateway devices according the mediation policy in effect.

7. The method of claim 1, wherein the administrator can define and modify multiple mediation policies, and wherein different policies may be applied to different end users.

8. The method of claim 1, wherein the administrator-defined schedule includes information indicative of:
at least one day of the week on which to apply the mediation policy; and
at least one predetermined period of time during the at least one day of the week to apply the mediation policy.

9. The method of claim 8, wherein the at least one predetermined period of time is the same for each day of the week.

10. The method of claim 1, wherein the administrator-defined schedule includes at least one of study time and free time.

11. The method of claim 10, wherein during study time the mediation policy is applied to the Internet service such that only Internet content included in the mediation policy is accessible, and during free time the mediation policy is not applied to the Internet service.

12. The method of claim 1, wherein the mediation policy is immediately applied to the Internet service upon a request received from an administrator.

13. The method of claim 1, further comprising creating a mediation policy by:
receiving information indicative of at least one of educationally appropriate Internet content defined by an administrator and an age of at least one end user;
locating educationally appropriate Internet content for the at least one end user from the received information indicative of the age of at least one end user;
receiving information indicative of an administrator-defined schedule including at least one day of the week on which to apply the mediation policy and at least one predetermined period of time during the at least one day of the week to apply the mediation policy; and
combining the received and located information to create the mediation policy.

14. The method of claim 13, further comprising creating a specific mediation policy for each end user accessing the Internet service.

15. The method of claim 13, wherein the administrator selectively applies the mediation policy to end users of the network.

16. The method of claim 13, wherein the mediation policy is at least one of (i) periodically and (ii) automatically and continuously updated.

17. The method of claim 16, wherein the mediation policy is updated by identifying additional Internet content, evaluating the identified Internet content to determine the educational appropriateness of the Internet content, and adding the evaluated Internet content to the mediation policy if the identified Internet content is determined to be educationally appropriate for the end user.

18. The method of claim 8, wherein during specified time periods, applying the mediation policy to the Internet service includes:
receiving a request to access Internet content from a computing system coupled to the Internet service;
comparing the requested Internet content to the mediation policy; and
mediating resolution performed by a DNS server if the requested Internet content is not included in the mediation policy.

19. The method of claim 18, wherein mediating resolution includes blocking a resolution performed by an Internet service provider if the requested Internet content is not included in the mediation policy.

20. The method of claim 1, further comprising outputting a notification that access to the Internet content is prohibited by the mediation policy.

21. The method of claim 18 wherein the administrator customizes the notification message.

22. The method of claim 1, wherein the Internet content includes any of a web site, a domain, a web page, a web address, a hyperlink, a URL, text, a picture, audio media and video media.

23. The method of claim 1, wherein the administrator can disable the mediation policy.

24. The method of claim 1, wherein a history of all mediated Internet content is stored and is accessible for processing, analysis, or reporting.

25. The method of claim 1, wherein the administrator is notified of attempts to access restricted Internet content.

26. The method of claim 1, wherein at least one element of the mediation policy is resident on the DNS server.

27. The method of claim 1, wherein at least one element of the mediation policy is enforced by the DNS server.

28. The method of claim 1, wherein the administrator specifies different mediation policies for different locations.

29. The method of claim 1, wherein the mediation policy is created by a collaborative effort from more than one user.

30. The method of claim 29, wherein at least one user is not a user of the network to which the mediation policy is applied.

31. The method of claim 1, wherein at least a portion of the Internet service resides on the user device

32. A system for mediating the delivery of Internet service at a specific location, the system comprising a memory for storing a program and a processor for executing the program that includes a mediation policy module that selectively applies a mediation policy to the Internet service of an administrator-defined schedule, the mediation policy including only Internet content with educational value, the educational Internet content being accessible when the mediation policy is applied to the Internet service, the Internet content comprising educationally appropriate Internet content for at least one end user.

33. The system of claim 32, wherein educationally appropriate Internet content includes Internet content received from an administrator.

34. The system of claim 33, wherein at least a portion of the educationally appropriate Internet content is received from an educational institute.

35. The system of claim 32, wherein the Internet service blocks delivery of Internet content to user devices according to the mediation policy in effect.

36. The system of claim 32, wherein the Internet service blocks delivery of Internet content to gateway devices according the mediation policy in effect.

37. The system of claim 32, wherein the administrator-defined schedule includes information indicative of:
at least one day of the week on which to apply the mediation policy; and
at least one predetermined period of time during the at least one day of the week to apply the mediation policy.

38. The system of claim 37, wherein the at least one predetermined period of time is the same for each day of the week.

39. The system of claim 32, wherein the administrator-defined schedule includes study time and free time.

40. The system of claim 39, wherein during study time the mediation policy is applied to the Internet service wherein only Internet content included in the mediation policy is accessible and during free time the mediation policy is not applied to the Internet service.

41. The system of claim 32, wherein the mediation policy is immediately applied by a dynamic enforcement engine of the system to the Internet service upon a request received from an administrator.

42. The system of claim 32, wherein the mediation policy module creates a mediation policy by:
receiving information indicative of at least one of educationally appropriate Internet content defined by an administrator and an age of at least one end user;
locating educationally appropriate Internet content for the at least one end user from the received information indicative of the age of at least one end user;
receiving information indicative of an administrator-defined schedule including at least one day of the week on which to apply the mediation policy and at least one predetermined period of time during the at least one day of the week to apply the mediation policy; and
combining the received and located information to create the mediation policy.

43. The system of claim 42, further comprising creating a mediation policy for each end user accessing the Internet service.

44. The system of claim 42, wherein the mediation policy is at least one of (i) periodically and (ii) automatically and continuously updated.

45. The system of claim 42, further comprising a gathering module to locate additional Internet content utilized to update a mediation policy, evaluate the located Internet content to determine the educational appropriateness of the Internet content, and add the evaluated Internet content to the mediation policy if the located Internet content is determined to be educationally appropriate for the end user.

46. The system of claim 35, wherein during study time, a policy application module applies the mediation policy to the Internet service by:
receiving a request to access Internet content from a computing system coupled to the Internet service;
comparing the requested Internet content to the mediation policy; and
causing a dynamic enforcement engine to block a resolution performed by a DNS server if the requested Internet content is not included in the mediation policy.

47. The system of claim 46, wherein blocking includes blocking a resolution performed by an Internet service provider if the requested Internet content is not included in the mediation policy.

48. The system of claim 47, further comprising outputting a notification that access to the Internet content is prohibited by the mediation policy.

49. The system of claim 32, wherein the Internet content includes any of a web site, a domain, a web page, a web address, a hyperlink, a URL, text, a picture, audio media and video media.

50. The system of claim 32, wherein the administrator selectively disables the mediation policy.

51. The system of claim 32, wherein at least one element of the mediation policy is resident on the DNS server.

52. The system of claim 32, wherein at least one element of the mediation policy is enforced by the DNS server.

53. The system of claim 32, wherein the administrator specifies a different mediation policy for different locations.

54. The system of claim 32, wherein the mediation policy is created by a collaborative effort from more than one user.

55. The system of claim 54, wherein at least one user is not a user of the network to which the mediation policy is applied.

56. The system of claim 32, wherein at least a portion of the Internet service resides on the user device.

57. A computer readable storage medium having a program embodied thereon, the program executable by a processor in a computing system to perform a method of mediating the delivery of Internet service, the method comprising:
executing instructions stored in a memory by a processor to selectively apply a mediation policy to the Internet service according to an administrator-defined schedule, the mediation policy including only Internet content that is accessible when the mediation policy is applied to the Internet service, the Internet content comprising educationally appropriate Internet content for at least one end user.

58. The computer readable storage medium of claim 57, the method further comprising creating a mediation policy by:
receiving information indicative of at least one of educationally appropriate Internet content defined by an administrator and an age of at least one end user;
locating educationally appropriate Internet content for the at least one end user from the received information indicative of the age of at least one end user;
receiving information indicative of an administrator-defined schedule including at least one day of the week on which to apply the mediation policy and at least one predetermined period of time during the at least one day of the week to apply the mediation policy; and
combining the received and located information to create the mediation policy.

59. A method for mediating the delivery of Internet service at a specific location, the method comprising:
selectively applying a mediation policy via a DNS server to the Internet service according to an administrator-defined schedule, the mediation policy including only Internet content with educational value, the educational Internet content being accessible when the mediation policy is applied to the Internet service through the DNS server, the Internet content comprising educationally appropriate Internet content for at least one end user.

60. The method of claim 59, wherein educationally appropriate Internet content includes Internet content identified by administrator.

61. The method of claim 59, wherein at least a portion of the educationally appropriate Internet content is defined by an educational institute.

62. The method of claim 59, wherein the mediation policy is created by the administrator or created by a group of users of the Internet service.

63. The method of claim 59, wherein at least a portion of the educationally appropriate Internet content is defined by groups of users of the Internet service.

64. The method of claim 59, wherein the Internet service blocks delivery of Internet content to user devices according to the mediation policy in effect.

65. The method of claim 59, wherein the Internet service blocks delivery of Internet content to gateway devices according the mediation policy in effect.

66. The method of claim 59, wherein the administrator can define and modify multiple mediation policies, and wherein different policies may be applied to different end users.

67. The method of claim 59, wherein the administrator-defined schedule includes information indicative of:
at least one day of the week on which to apply the mediation policy; and
at least one predetermined period of time during the at least one day of the week to apply the mediation policy.

68. The method of claim 59, wherein the at least one predetermined period of time is the same for each day of the week.

69. The method of claim 59, wherein the administrator-defined schedule includes at least one of study time and free time.

70. The method of claim 69, wherein during study time the mediation policy is applied to the Internet service via the DNS server such that only Internet content included in the mediation policy is accessible, and during free time the mediation policy is not applied to the Internet service.

71. The method of claim 59, wherein the mediation policy is immediately applied to the Internet service via a DNS server upon a request received from an administrator.

72. The method of claim 59, further comprising creating a mediation policy by:
receiving information indicative of at least one of educationally appropriate Internet content defined by an administrator and an age of at least one end user;
locating educationally appropriate Internet content for the at least one end user from the received information indicative of the age of at least one end user;
receiving information indicative of an administrator-defined schedule including at least one day of the week on which to apply the mediation policy and at least one predetermined period of time during the at least one day of the week to apply the mediation policy; and
combining the received and located information to create the mediation policy.

73. The method of claim 72, further comprising creating a specific mediation policy for each end user accessing the Internet service.

74. The method of claim 72, wherein the administrator selectively applies via the DNS server the mediation policy to end users of the network.

75. The method of claim 72, wherein the mediation policy is at least one of (i) periodically and (ii) automatically and continuously updated.

76. The method of claim 75, wherein the mediation policy is updated by identifying additional Internet content, evaluating the identified Internet content to determine the educational appropriateness of the Internet content, and adding the evaluated Internet content to the mediation policy if the identified Internet content is determined to be educationally appropriate for the end user.

77. The method of claim 59, wherein during specified time periods, applying the mediation policy via a DNS server to the Internet service includes:
receiving a request to access Internet content from a computing system coupled to the Internet service;
comparing the requested Internet content to the mediation policy; and
mediating resolution performed by a DNS server if the requested Internet content is not included in the mediation policy.

78. The method of claim 77, wherein mediating resolution includes blocking a resolution performed by an Internet service provider if the requested Internet content is not included in the mediation policy.

79. The method of claim 59, further comprising outputting a notification that access to the Internet content is prohibited by the mediation policy.

80. The method of claim 59, wherein the Internet content includes any of a web site, a domain, a web page, a web address, a hyperlink, a URL, text, a picture, audio media and video media.

81. The method of claim 59, wherein the administrator selectively disables the mediation policy.

82. The method of claim 59, wherein the administrator specifies different mediation policies for different locations.

83. The method of claim 59, wherein the mediation policy is created by a collaborative effort from more than one user.

84. The method of claim 83, wherein at least one user is not a user of the network to which the mediation policy is applied.

85. The method of claim 59, wherein a portion of the Internet service resides on the user device.

86. A system for mediating the delivery of Internet service at a specific location, the system comprising:
a memory for storing a program and a processor for executing the program that includes a mediation policy module that selectively applies through a DNS server a mediation policy to the Internet service according to an administrator-defined schedule, the mediation policy including only Internet content with educational value, the educational Internet content being accessible when the mediation policy is applied to the Internet service, the Internet content comprising educationally appropriate Internet content for at least one end user.

87. The system of claim 86, wherein educationally appropriate Internet content includes Internet content received from an administrator.

88. The system of claim 87, wherein at least a portion of the educationally appropriate Internet content is received from an educational institute.

89. The system of claim 86, wherein the administrator-defined schedule includes information indicative of:
at least one day of the week on which to apply the mediation policy; and
at least one predetermined period of time during the at least one day of the week to apply the mediation policy.

90. The system of claim 89, wherein the at least one predetermined period of time is the same for each day of the week.

91. The system of claim 86, wherein the administrator-defined schedule includes study time and free time.

92. The system of claim 91, wherein during study time the mediation policy is applied to the Internet service wherein only Internet content included in the mediation policy is accessible and during free time the mediation policy is not applied to the Internet service.

93. The system of claim 86, wherein the mediation policy is immediately applied by a dynamic enforcement engine of the system to the Internet service upon a request received from an administrator.

94. The system of claim 86, wherein the mediation policy module creates a mediation policy by:
receiving information indicative of at least one of educationally appropriate Internet content defined by an administrator and an age of at least one end user;
locating educationally appropriate Internet content for the at least one end user from the received information indicative of the age of at least one end user;
receiving information indicative of an administrator-defined schedule including at least one day of the week on which to apply the mediation policy and at least one predetermined period of time during the at least one day of the week to apply the mediation policy; and
combining the received and located information to create the mediation policy.

95. The system of claim 94, further comprising creating a mediation policy for each end user accessing the Internet service.

96. The system of claim 94, wherein the mediation policy is at least one of (i) periodically and (ii) automatically and continuously updated.

97. The system of claim 94, further comprising a gathering module to locate additional Internet content utilized to update a mediation policy, evaluate the located Internet content to determine the educational appropriateness of the Internet content, and add the evaluated Internet content to the mediation policy if the located Internet content is determined to be educationally appropriate for the end user.

98. The system of claim 89, wherein during study time, a policy application module applies the mediation policy to the Internet service by:
receiving a request to access Internet content from a computing system coupled to the Internet service;
comparing the requested Internet content to the mediation policy; and
causing a dynamic enforcement engine to block a resolution performed by a DNS server if the requested Internet content is not included in the mediation policy.

99. The system of claim 98, wherein blocking includes blocking a resolution performed by an Internet service provider if the requested Internet content is not included in the mediation policy.

100. The system of claim 99, further comprising outputting a notification that access to the Internet content is prohibited by the mediation policy.

101. The system of claim 86, wherein the Internet content includes any of a web site, a domain, a web page, a web address, a hyperlink, a URL, text, a picture, audio media and video media.

102. The system of claim 86, wherein the mediation policy is created by a collaborative effort from more than one user.

103. The system of claim 102, wherein at least one user is not a user of the network to which the mediation policy is applied.

104. The system of claim 86, wherein a portion of the Internet service resides on the user device.
